(19) United States
(12) Patent Application Publication
(10) Pub. No.: US 2010/0149333 A1
(43) Pub. Date: Jun. 17, 2010

(54) OBSTACLE SENSING APPARATUS

(75) Inventor: Changhui YANG, Osaka-shi (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/638,279

(22) Filed: Dec. 15, 2009

(30) Foreign Application Priority Data
Dec. 15, 2008 (JP) 2008-318860

(51) Int. Cl. H04N 7/00

(52) U.S. Cl. 348/143; 348/E07.001

(57) ABSTRACT

An obstacle sensing apparatus includes a plurality of cameras which repeatedly outputs object scene images representing an object scene in a direction which obliquely intersects a ground. A CPU transforms each of the object scene images into a bird's-eye view image, and detects a difference between screens of the transformed bird's-eye view image. Moreover, the CPU specifies one portion of difference along a connecting line axis extending in parallel to the ground from each of reference points corresponding to centers of imaging surfaces of the cameras. Furthermore, the CPU specifies one portion of difference along a connecting-line-vertical axis extending in parallel to the ground in a manner to intersect the connecting line axis. When the differences thus specified satisfies a predetermined condition, the CPU multiplexes a rectangular character onto a maneuver assisting image corresponding to a position of an obstacle area, in order to notify the existence of an obstacle.

### CROSS REFERENCE OF RELATED APPLICATION

The disclosure of Japanese Patent Application No. 2008-318860, which was filed on Dec. 15, 2008, is incorporated herein by reference.

### BACKGROUND OF THE INVENTION

1. Field of the Invention

The present invention relates to an obstacle sensing apparatus. In particular, the present invention relates to an obstacle sensing apparatus, arranged in a moving object such as an automobile, which senses a surrounding obstacle.

2. Description of the Related Art

According to one example of this type of apparatus, an image representing an object scene around a vehicle is repeatedly outputted from an imaging device mounted on a vehicle. An image processing unit transforms each of two images outputted from an imaging device into a bird's-eye view image, aligns positions of the two transformed bird's-eye view images, and detects a difference between the two bird's-eye view images in which the positions are aligned. In the detected difference, a component equivalent to an obstacle having a height appears. Thereby, it becomes possible to sense the obstacle from an object scene.

However, in the above-described device, resulting from an error in the process for transforming into a bird's-eye view image and an error in the process for aligning positions, the accuracy for sensing the obstacle may be deteriorated.

### SUMMARY OF THE INVENTION

An obstacle sensing apparatus according to the present invention, comprises: a fetcher which fetches an object scene image repeatedly outputted from an imager which captures an object scene in a direction which obliquely intersects a reference surface; a transformer which transforms the object scene image fetched by the fetcher into a bird's-eye view image; a detector which detects a difference between screens of the bird's-eye view image transformed by the transformer; a first specifier which specifies one portion of difference along a first axis extending in parallel to the reference surface from a reference point corresponding to a center of an imaging surface, out of the difference detected by the detector; a second specifier which specifies one portion of difference along a second axis extending in parallel to the reference surface in a manner to intersect the first axis, out of the difference detected by the detector; and a generator which generates a notification when the difference specified by the first specifier and the difference specified by the second specifier satisfy a predetermined condition.

Preferably, further comprised is a first definer which defines the first axis corresponding to each of one or at least two angles in a rotation direction of a reference axis extending from the reference point in a manner to be perpendicular to the reference surface, wherein the first specifier executes a difference specifying process in association with a defining process of the first definer.

More preferably, further comprised is a creator which creates a histogram representing a distributed state in the rotation direction of the difference detected by the detector, wherein the first definer executes the defining process with reference to the histogram created by the creator.

More preferably, further comprised is a second definer which defines the second axis in each of one or at least two positions corresponding to the difference specified by the first specifier, wherein the second specifier executes a difference specifying process in association with a defining process of the second definer.

Preferably, the difference specified by the second specifier is equivalent to a difference continuously appearing along the second axis.

Preferably, the predetermined condition is equivalent to a condition under which a size of the difference specified by the first specifier exceeds a first threshold value and a size of the difference specified by the second specifier falls below a second threshold value.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of the present invention;

FIG. 2(A) is an illustrative view showing a state where a front side of an automobile is seen;

FIG. 2(B) is an illustrative view showing a state where a right side of the automobile is seen;

FIG. 2(C) is an illustrative view showing a state where a rear side of the automobile is seen;

FIG. 2(D) is an illustrative view showing a state where a left side of the automobile is seen;

FIG. 3 is an illustrative view showing one example of a viewing field captured by a plurality of cameras attached to the automobile;

FIG. 4(A) is an illustrative view showing one example of a bird's-eye view image based on output of a front camera;

FIG. 4(B) is an illustrative view showing one example of a bird's-eye view image based on output of a right camera;

FIG. 4(C) is an illustrative view showing one example of a bird's-eye view image based on output of a left camera;

FIG. 4(D) is an illustrative view showing one example of a bird's-eye view image based on output of a rear camera;

FIG. 5 is an illustrative view showing one example of a whole-circumference bird's-eye view image based on the bird's-eye view images shown in FIG. 4(A) to FIG. 4(D);

FIG. 6 is an illustrative view showing one example of a maneuver assisting image displayed by a display device;

FIG. 7 is an illustrative view showing an angle of a camera attached to the automobile;

FIG. 8 is an illustrative view showing a relationship among a camera coordinate system, a coordinate system of an imaging surface, and a world coordinate system;

FIG. 9 is a perspective view showing one example of an automobile, and an obstacle and a pattern existing near the automobile;

FIG. 10 is an illustrative view showing another example of the whole-circumference bird's-eye view image;

FIG. 11(A) is an illustrative view showing one portion of a reproduced image;

FIG. 11(B) is an illustrative view showing one portion of a difference image corresponding to the reproduced image shown in FIG. 11(A);

FIG. 12 is a histogram showing a distributed state of luminance corresponding to the difference image shown in FIG. 11(B);

FIG. 13 is an illustrative view showing one example of a connecting line axis and a connecting-line vertical axis defined on the difference image shown in FIG. 11(B);

FIG. 14(A) is a graph showing a change in luminance of a difference image relative to a connecting line axis in an angle θ1;

FIG. 14(B) is a graph showing a change in luminance of a difference image relative to a vertical axis orthogonal to the connecting line axis in the angle θ1;

FIG. 15(A) is a graph showing a change in luminance of a difference image relative to a connecting line axis in an angle θ2;

FIG. 15(B) is a graph showing a change in luminance of a difference image relative to a vertical axis orthogonal to the connecting line axis in the angle θ2;

FIG. 16(A) is a graph showing a change in luminance of a difference image relative to a connecting line axis in an angle θ3;

FIG. 16(B) is a graph showing a change in luminance of a difference image relative to a vertical axis orthogonal to the connecting line axis in the angle θ3;

FIG. 17(A) is a graph showing a change in luminance of a difference image relative to a connecting line axis in an angle θ4;

FIG. 17(B) is a graph showing a change in luminance of a difference image relative to a vertical axis orthogonal to the connecting line axis in the angle θ4;

FIG. 18(A) is a graph showing a change in luminance of a difference image relative to a connecting line axis in an angle θ5;

FIG. 18(B) is a graph showing a change in luminance of a difference image relative to a vertical axis orthogonal to the connecting line axis in the angle θ5;

FIG. 19 is an illustrative view showing another example of the maneuver assisting image displayed by the display device;

FIG. 20 is a flowchart showing one portion of an operation of a CPU applied to the embodiment in FIG. 1;

FIG. 21 is a flowchart showing another portion of the operation of the CPU applied to the embodiment in FIG. 1;

FIG. 22 is a flowchart showing still another portion of the operation of the CPU applied to the embodiment in FIG. 1; and

FIG. 23 is a flowchart showing yet still another portion of the operation of the CPU applied to the embodiment in FIG. 1.

### DETAILED DESCRIPTION OF THE PREFERRED EMBODIMENTS

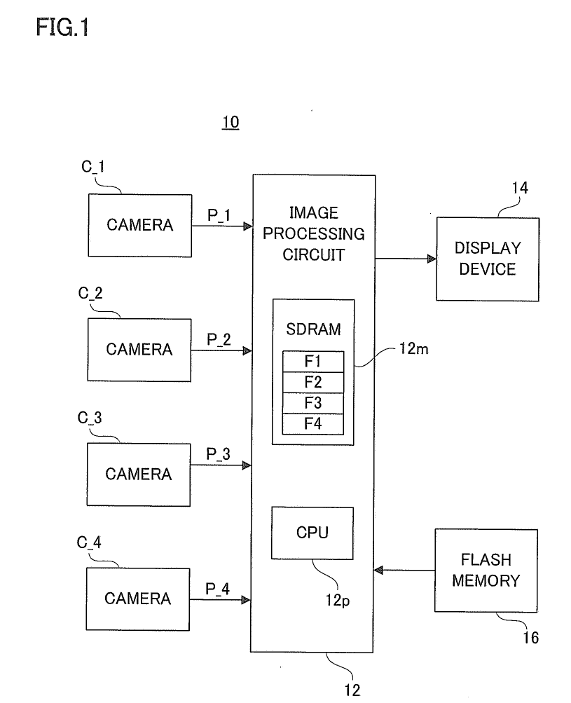

A maneuver assisting apparatus (obstacle sensing apparatus) 10 of this embodiment shown in FIG. 1 includes four cameras C_1 to C_4. The cameras C_1 to C_4 respectively output object scene images P_1 to P_4 for each 1/30 seconds, responding to a common vertical synchronization signal Vsync. The outputted object scene images P_1 to P_4 are fetched by an image processing circuit 12. The fetched object scene images P_1 to P_4 are respectively written in work areas F1 to F4 of an SDRAM 12m.

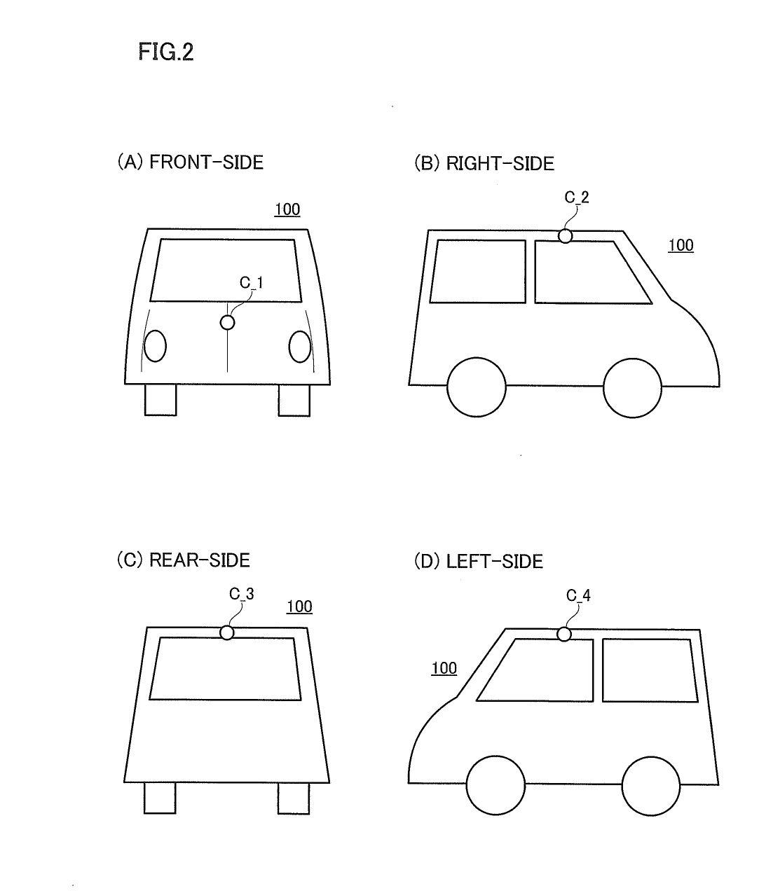

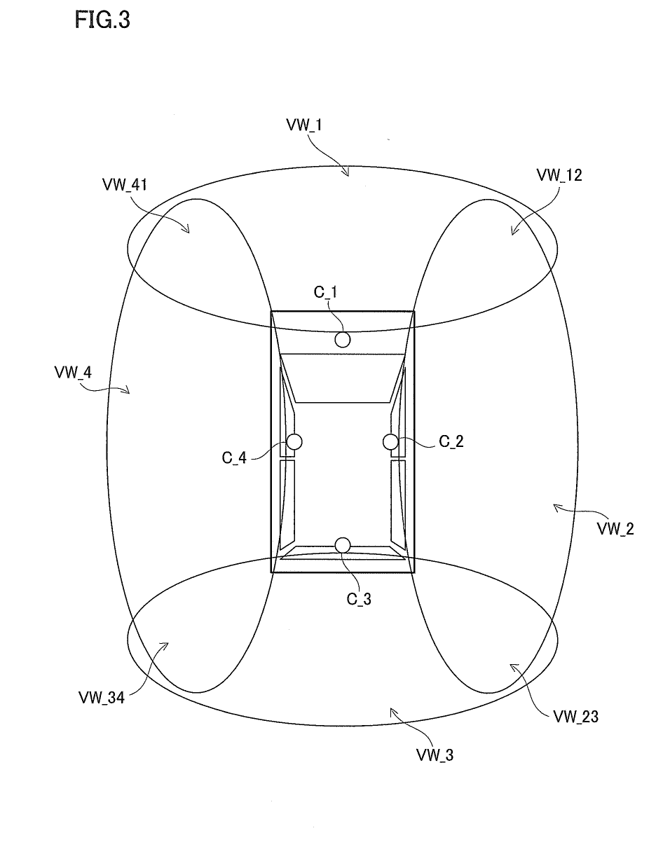

With reference to FIG. 2(A) to FIG. 2(D), the maneuver assisting apparatus 10 is mounted on an automobile 100 traveling on a ground. Specifically, the camera C_1 is installed at a substantially center of a front portion of the automobile 100 and oriented forward, obliquely downward of the automobile 100. The camera C_2 is installed at a substantially center in a width direction on a right side and on an upper side in a height direction of the automobile 100, and oriented rightward, obliquely downward of the automobile 100.

The camera C_3 is installed at a substantially center in a width direction of a rear portion and on an upper side in a height direction of the automobile 100, and oriented rearward, obliquely downward of the automobile 100. The camera C_4 is installed at a substantially center in a width direction on a left side and on an upper side in a height direction of the automobile 100, and oriented leftward, obliquely downward direction of the automobile 100.

A state where the automobile 100 and its surrounding grounds are aerially viewed is shown in FIG. 3. According to FIG. 3, the camera C_1 has a viewing field VW_1 capturing a front of the automobile 100, the camera C_2 has a viewing field VW_2 capturing a right direction of the automobile 100, the camera C_3 has a viewing field VW_3 capturing a rear of the automobile 100, and the camera C_4 has a viewing field VW_4 capturing a left direction of the automobile 100. Furthermore, the viewing fields VW_1 and VW_2 have a common viewing field VW_12, the viewing fields VW_2 and VW_3 have a common viewing field VW_23, the viewing fields VW_3 and VW_4 have a common viewing field VW_34, and the viewing fields VW_4 and VW_1 have a common viewing field VW_41.

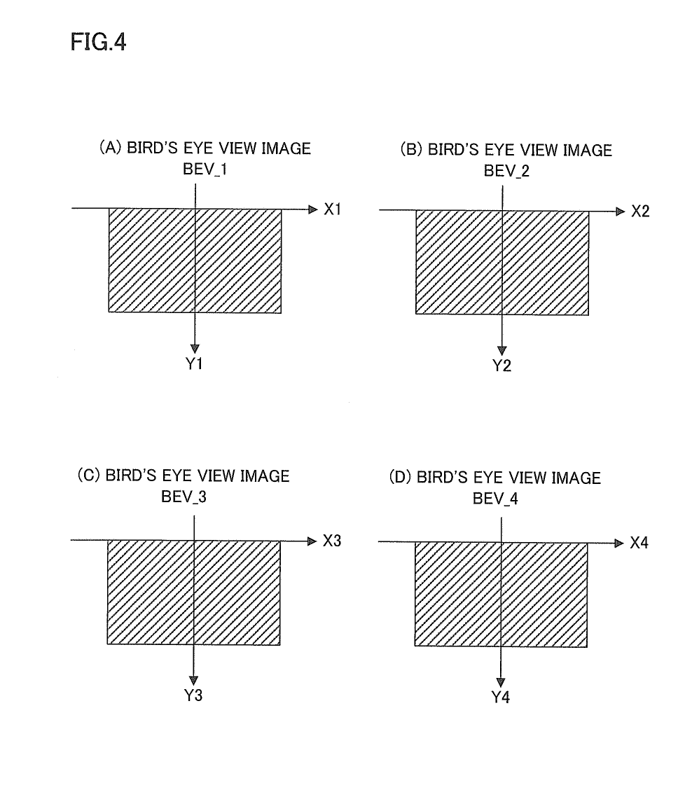

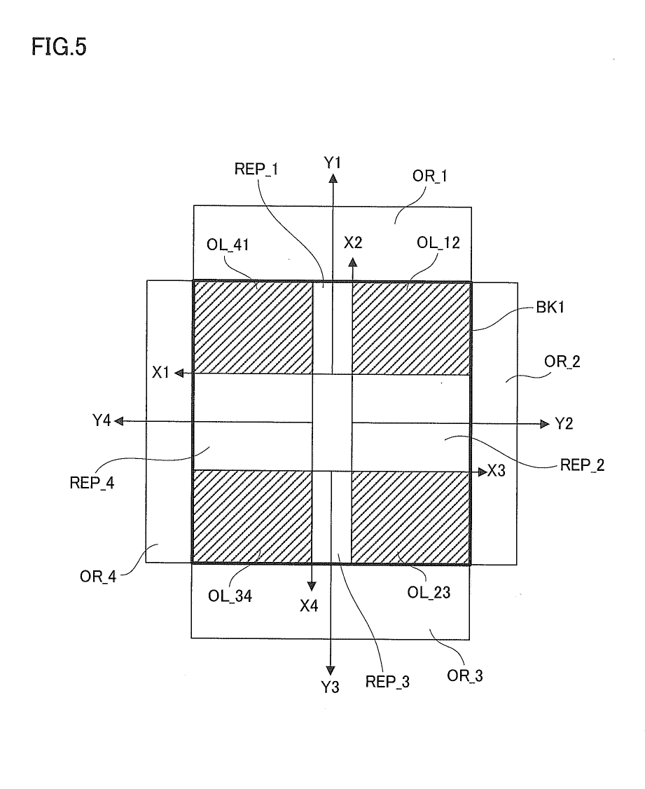

Returning to FIG. 1, a CPU 12p arranged in the image processing circuit 12 produces a bird's-eye view image BEV_1 shown in FIG. 4(A) based on the object scene image P_1 accommodated in the work area F1, and produces a bird's-eye view image BEV_2 shown in FIG. 4(B) based on the object scene image P_2 accommodated in the work area F2. Moreover, the CPU 12p produces a bird's-eye view image BEV_3 shown in FIG. 4(C) based on the object scene image P_3 accommodated in the work area F3, and produces a bird's-eye view image BEV_4 shown in FIG. 4(D) based on the object scene image P_4 accommodated in the work area F4. The bird's-eye view images BEV_1 to BEV_4 are also accommodated in the work areas F1 to F4.

The bird's-eye view image BEV_1 is equivalent to an image captured by a virtual camera looking perpendicularly down on the viewing field VW_1, and the bird's-eye view image BEV_2 is equivalent to an image captured by a virtual camera looking perpendicularly down on the viewing field VW_2. Moreover, the bird's-eye view image BEV_3 is equivalent to an image captured by a virtual camera looking perpendicularly down on the viewing field VW_3, and the bird's-eye view image BEV_4 is equivalent to an image captured by a virtual camera looking perpendicularly down on the viewing field VW_4.

According to FIG. 4(A) to FIG. 4(D), the bird's-eye view image BEV_1 has a bird's-eye-view coordinate system (X1, Y1), the bird's-eye view image BEV_2 has a bird's-eye-view coordinate system (X2, Y2), the bird's-eye view image BEV_3 has a bird's-eye-view coordinate system (X3, Y3), and the bird's-eye view image BEV_4 has a bird's-eye-view coordinate system (X4, Y4).

Subsequently, in order to join the bird's-eye view images BEV_1 to BEV_4 each other, the CPU 12p rotates and/or moves the bird's-eye view images BEV_2 to BEV_4 by using the bird's-eye view image BEV_1 as a reference. The coordinates of the bird's-eye view images BEV_2 to BEV_4 are transformed on the work areas F2 to F4 so as to depict a whole-circumference bird's-eye view image shown in FIG. 5.

In FIG. 5, an overlapped area OL_12 is equivalent to an area for reproducing the common viewing field VW_12, and an overlapped area OL_23 is equivalent to an area for reproducing the common viewing field VW_23. Moreover, an overlapped area OL_34 is equivalent to an area for reproducing the common viewing field VW_34, and an overlapped area OL_41 is equivalent to an area for reproducing the common viewing field VW_41.

Moreover, a unique area OR_1 is equivalent to an area for reproducing one portion of a viewing field of the viewing field VW1 except for the common viewing fields VW_41 and VW_12, and a unique area OR_2 is equivalent to an area for reproducing one portion of a viewing field of the viewing field VW2 except for the common viewing fields VW_12 and VW_23. Furthermore, a unique area OR_3 is equivalent to an area for reproducing one portion of a viewing field of the viewing field VW3 except for the common viewing fields VW_23 and VW_34, and a unique area OR_4 is equivalent to an area for reproducing one portion of a viewing field of the viewing field VW4 except for the common viewing fields VW_34 and VW_41.

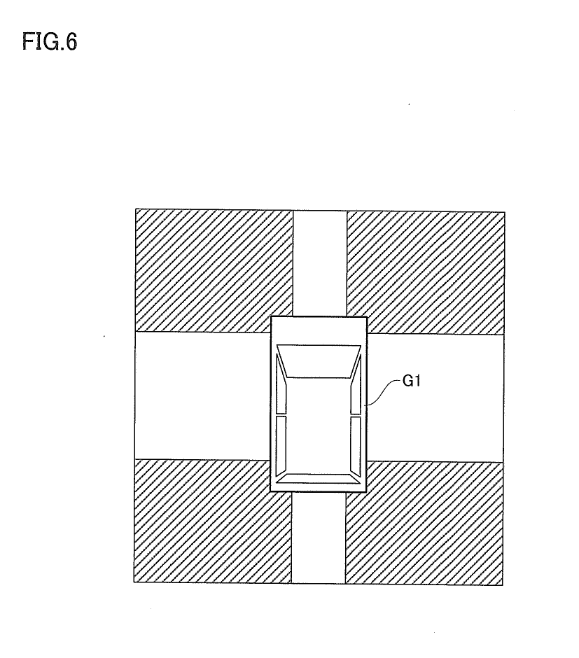

A display device 14 installed in a driver's seat on the automobile 100 defines a block BK1 in which the overlapped areas OL_12 to OL_41 are located at four corners, and reads out one portion of the bird's-eye view image belonging to the defined block BLK1 from each of the work areas F1 to F4. Moreover, the display device 14 joins the read-out bird's-eye view images each other, and pastes a graphic image G1 resembling an upper portion of the automobile 100, at a center of the thus-obtained whole-circumference bird's-eye view image. As a result, a maneuver assisting image shown in FIG. 6 is displayed on a monitor screen.

Subsequently, a manner of creating the bird's-eye view images BEV_1 to BEV_4 is described. It is noted that all the bird's-eye view images BEV_1 to BEV_4 are created according to the same manner, and therefore, on behalf of all the bird's-eye view images BEV_1 to BEV_4, the manner of creating the bird's-eye view image BEV_3 is described.

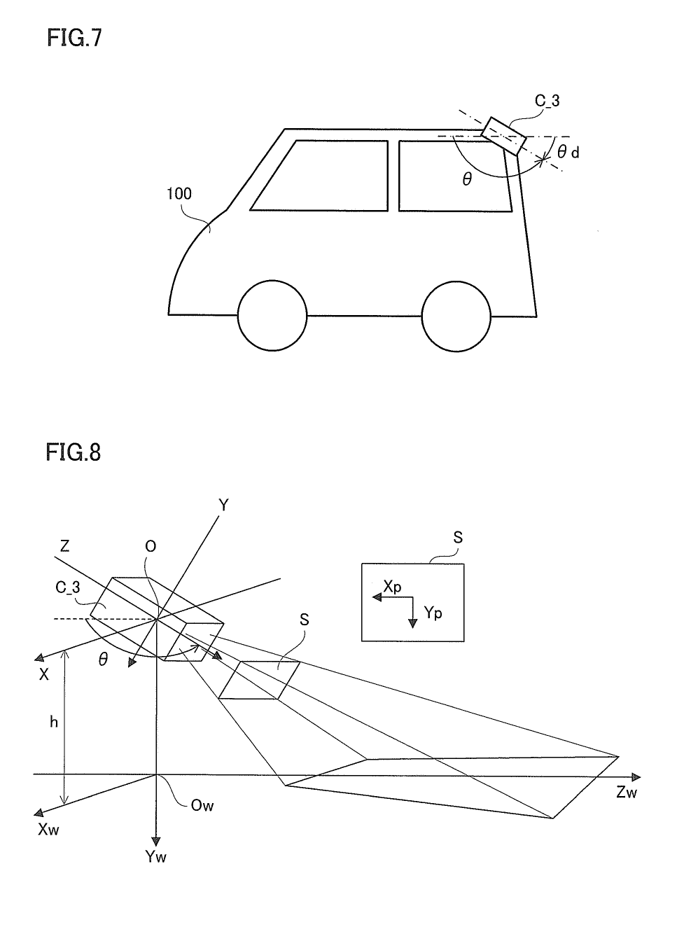

With reference to FIG. 7, the camera C_3 is placed to be orientated rearward, obliquely downward of the rear portion of the automobile 100. If an angle of depression of the camera C_3 is assumed as “θd”, an angle θ shown in FIG. 7 is equivalent to “180 degrees-θd”. Furthermore, the angle θ is defined in a range of 90 degrees<θ<180 degrees.

FIG. 8 shows a relationship among a camera coordinate system (X, Y, Z), a coordinate system (Xp, Yp) of an imaging surface S of the camera C_3, and a world coordinate system (Xw, Yw, Zw). The camera coordinate system (X, Y, Z) is a three-dimensional coordinate system where an X axis, Y axis, and Z axis are coordinate axes. The coordinate system (Xp, Yp) is a two-dimensional coordinate system where an Xp axis and Yp axis are coordinate axes. The world coordinate system (Xw, Yw, Zw) is a three-dimensional coordinate system where an Xw axis, Yw axis, and Zw axis are coordinate axes.

In the camera coordinate system (X, Y, Z), an optical center of the camera C3 is used as an origin O, and in this state, the Z axis is defined in an optical axis direction, the X axis is defined in a direction orthogonal to the Z axis and parallel to the ground, and the Y axis is defined in a direction orthogonal to the Z axis and X axis. In the coordinate system (Xp, Yp) of the imaging surface S, a center of the imaging surface S is used as the origin, and in this state, the Xp axis is defined in a lateral direction of the imaging surface S and the Yp axis is defined in a vertical direction of the imaging surface S.

In the world coordinate system (Xw, Yw, Zw), an intersecting point between a perpendicular line passing through the origin O of the camera coordinate system (X, Y, Z) and the ground is used as an origin Ow, and in this state, the Yw axis is defined in a direction vertical to the ground, the Xw axis is defined in a direction parallel to the X axis of the camera coordinate system (X, Y, Z), and the Zw axis is defined in a direction orthogonal to the Xw axis and Yw axis. Also, a distance from the Xw axis to the X axis is “h”, and an obtuse angle formed by the Zw axis and the Z axis is equivalent to the above described angle θ.

When coordinates in the camera coordinate system (X, Y, Z) are written as (x, y, z), “x”, “y”, and “z” indicate an X-axis component, a Y-axis component, and a Z-axis component, respectively, in the camera coordinate system (X, Y, Z). When coordinates in the coordinate system (Xp, Yp) of the imaging surface S are written as (xp, yp), “xp” and “yp” indicate an Xp-axis component and a Yp-axis component, respectively, in the coordinate system (Xp, Yp) of the imaging surface S. When coordinates in the world coordinate system (Xw, Yw, Zw) are written as (xw, yw, zw), “xw”, “yw”, and “zw” indicate an Xw-axis component, a Yw-axis component, and a Zw-axis component, respectively, in the world coordinate system (Xw, Yw, Zw).

A transformation equation between the coordinates (x, y, z) of the camera coordinate system (X, Y, Z) and the coordinates (xw, yw, zw) of the world coordinate system (Xw, Yw, Zw) is represented by Equation 1 below:

$$[ \begin{matrix}x \\ y \\ z\end{matrix} ] = [ \begin{matrix}1 & 0 & 0 \\ 0 & cos θ & - sin θ \\ 0 & sin θ & cos θ\end{matrix} ] \{ [ \begin{matrix}xw \\ yw \\ zw\end{matrix} ] + [ \begin{matrix}0 \\ h \\ 0\end{matrix} ] \} \qquad [ Equation 1 ]$$

Herein, if a focal length of the camera C_3 is assumed as “f”, a transformation equation between the coordinates (xp, yp) of the coordinate system (Xp, Yp) of the imaging surface S and the coordinates (x, y, z) of the camera coordinate system (X, Y, Z) is represented by Equation 2 below:

$$[ \begin{matrix}xp \\ yp\end{matrix} ] = [ \begin{matrix}f \frac{x}{z} \\ f \frac{y}{z}\end{matrix} ] \qquad [ Equation 2 ]$$

Furthermore, based on Equation 1 and Equation 2, Equation 3 is obtained. Equation 3 shows a transformation equation between the coordinates (xp, yp) of the coordinate system (Xp, Yp) of the imaging surface S and the coordinates (xw, zw) of the two-dimensional ground coordinate system (Xw, Zw).

$$[ \begin{matrix}xp \\ yp\end{matrix} ] = [ \begin{matrix}\frac{fxw}{h sin θ + zw cos θ} \\ \frac{( h cos θ - zw sin θ ) f}{h sin θ + zw cos θ}\end{matrix} ] \qquad [ Equation 3 ]$$

Furthermore, the bird's-eye-view coordinate system (X3, Y3), which is a coordinate system of the bird's-eye view image BEV_3 shown in FIG. 4(C), is defined. The bird's-eye-view coordinate system (X3, Y3) is a two-dimensional coordinate system where an X3 axis and Y3 axis are used as coordinate axes. When coordinates in the bird's-eye-view coordinate system (X3, Y3) are written as (x3, y3), a position of each pixel forming the bird's-eye view image BEV_3 is represented by coordinates (x3, y3). “x3” and “y3” respectively indicate an X3-axis component and a Y3-axis component in the bird's-eye-view coordinate system (X3, Y3).

A projection from the two-dimensional coordinate system (Xw, Zw) that represents the ground, onto the bird's-eye-view coordinate system (X3, Y3), is equivalent to a so-called parallel projection. When a height of a virtual camera, i.e., a′virtual view point, is assumed as “H”, a transformation equation between the coordinates (xw, zw) of the two-dimensional coordinate system (Xw, Zw) and the coordinates (x3, y3) of the bird's-eye-view coordinate system (X3, Y3) is represented by Equation 4 below. A height H of the virtual camera is previously determined.

$$[ \begin{matrix}x 3 \\ y 3\end{matrix} ] = \frac{f}{H} [ \begin{matrix}xw \\ zw\end{matrix} ] \qquad [ Equation 4 ]$$

Furthermore, based on Equation 4, Equation 5 is obtained, and based on Equation 5 and Equation 3, Equation 6 is obtained. Moreover, based on Equation 6, Equation 7 is obtained. Equation 7 is equivalent to a transformation equation for transforming the coordinates (xp, yp) of the coordinate system (Xp, Yp) of the imaging surface S into the coordinates (x3, y3) of the bird's-eye-view coordinate system (X3, Y3).

$$\begin{matrix}[ \begin{matrix}x w \\ z w\end{matrix} ] = \frac{H}{f} [ \begin{matrix}x 3 \\ y 3\end{matrix} ] & [ Equation 5 ] \\ [ \begin{matrix}xp \\ yp\end{matrix} ] = [ \begin{matrix}\frac{fHx 3}{fh sin θ + Hy 3 cos θ} \\ \frac{f ( fh cos θ - Hy 3 sin θ )}{fh sin θ + Hy 3 cos θ}\end{matrix} ] & [ Equation 6 ] \\ [ \begin{matrix}x 3 \\ y 3\end{matrix} ] = [ \begin{matrix}\frac{xp ( fh sin θ + Hy 3 cos θ )}{fH} \\ \frac{fh ( f cos θ - yp sin θ )}{H ( f sin θ + yp cos θ )}\end{matrix} ] & [ Equation 7 ]\end{matrix}$$

The coordinates (xp, yp) of the coordinate system (Xp, Yp) of the imaging surface S represent coordinates of the object scene image P_3 captured by the camera C_3. Therefore, the object scene image P_3 from the camera C_3 is transformed into the bird's-eye view image BEV_3 by using Equation 7. In reality, the object scene image P_3 firstly undergoes an image process such as a lens distortion correction, and is then transformed into the bird's-eye view image BEV_3 using Equation 7.

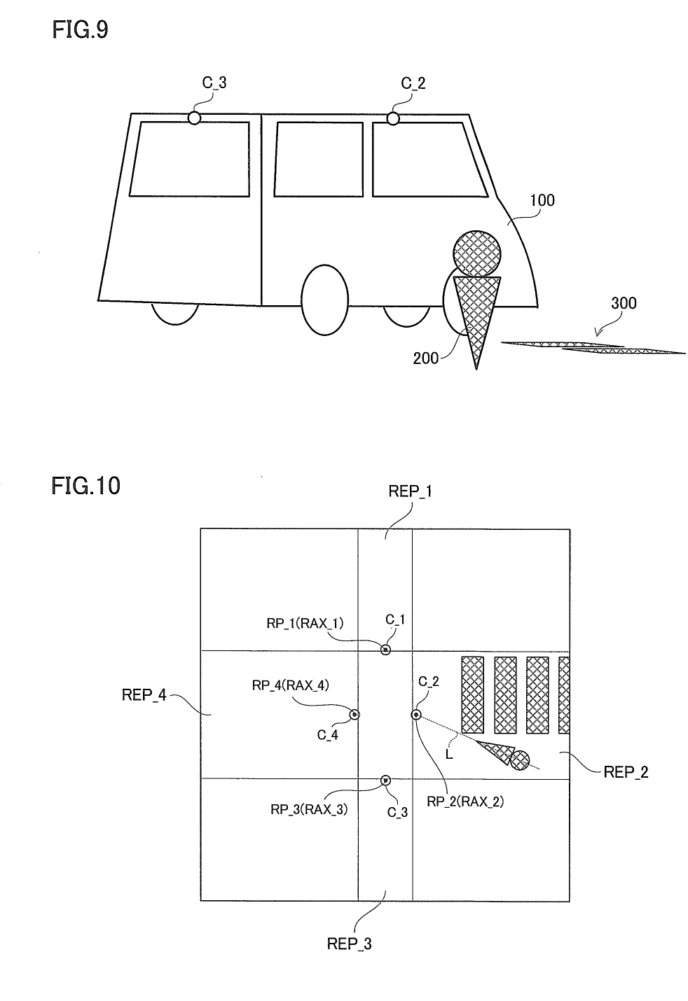

With reference to FIG. 9, when a dynamic obstacle 200 having a pattern depicted on its surface is present around the automobile 100, and a pattern 300 such as a crosswalk is depicted on a ground around the automobile 100, the obstacle 200 is sensed according to a manner described below.

In this embodiment, an obstacle showing a relative movement between the obstacle 200 and the automobile 100 is defined as a “dynamic obstacle”. Therefore, an obstacle moving around a stationary automobile 100, a stationary obstacle around a moving automobile 100, an obstacle moving at a speed different from a moving speed of the automobile 100, or an obstacle moving in a direction different from the moving direction of the automobile 100 is regarded as the “dynamic obstacle”. In contrary, a stationary obstacle around a stationary automobile 100, or an obstacle moving in the same direction as the moving direction of the automobile 100 at the same speed as the moving speed of the automobile 100 is regarded as a “static obstacle”.

In a situation shown in FIG. 9, a whole-circumference bird's-eye view image shown in FIG. 10 is created corresponding to the above-described block BK1. The obstacle 200 is a steric object captured by the camera C_2, and thus, an image of the obstacle 200 is reproduced as if to have fallen along a connecting line L linking the camera C_2 and a bottom of the obstacle 200.

In the description below, of the whole-circumference bird's-eye view image shown in FIG. 10, one portion of the image reproduced corresponding to the unique area OR_1 shown in FIG. 5 is defined as a “reproduced image REP_1”, and one portion of the image reproduced corresponding to the unique area OR_2 shown in FIG. 5 is defined as a “reproduced image REP_2”. Likewise, of the bird's-eye view image shown in FIG. 10, one portion of the image reproduced corresponding to the unique area OR_3 shown in FIG. 5 is defined as a “reproduced image REP_3”, and one portion of the image reproduced corresponding to the unique area OR_4 shown in FIG. 5 is defined as a “reproduced image REP_4”.

Moreover, with reference to FIG. 10, a point that is present on the whole-circumference bird's-eye view image and that is equivalent to a center of the imaging surface of the camera C_1 is defined as a “reference point RP_1”, and an axis extending from the reference point RP_1 orthogonally to the ground is defined as a “reference axis RAX_1”. Likewise, a point that is present on the whole-circumference bird's-eye view image and that is equivalent to a center of the imaging surface of the camera C_2 is defined as a “reference point RP_2”, and an axis extending from the reference point RP_2 orthogonally to the ground is defined as a “reference axis RAX_2”.

Moreover, a point that is present on the whole-circumference bird's-eye view image and that is equivalent to a center of the imaging surface of the camera C_3 is defined as a “reference point RP_3”, and an axis extending from the reference point RP_3 orthogonally to the ground is defined as a “reference axis RAX_3”. Likewise, a point that is present on the whole-circumference bird's-eye view image and that is equivalent to a center of the imaging surface of the camera C_4 is defined as a “reference point RP_4”, and an axis extending from the reference point RP_4 orthogonally to the ground is defined as a “reference axis RAX_4”.

In the image processing circuit 12, in response to the vertical synchronization signal Vsync, a variable L is set to each of “1” to “4”, and corresponding to each of the numerical values, the process described below is executed.

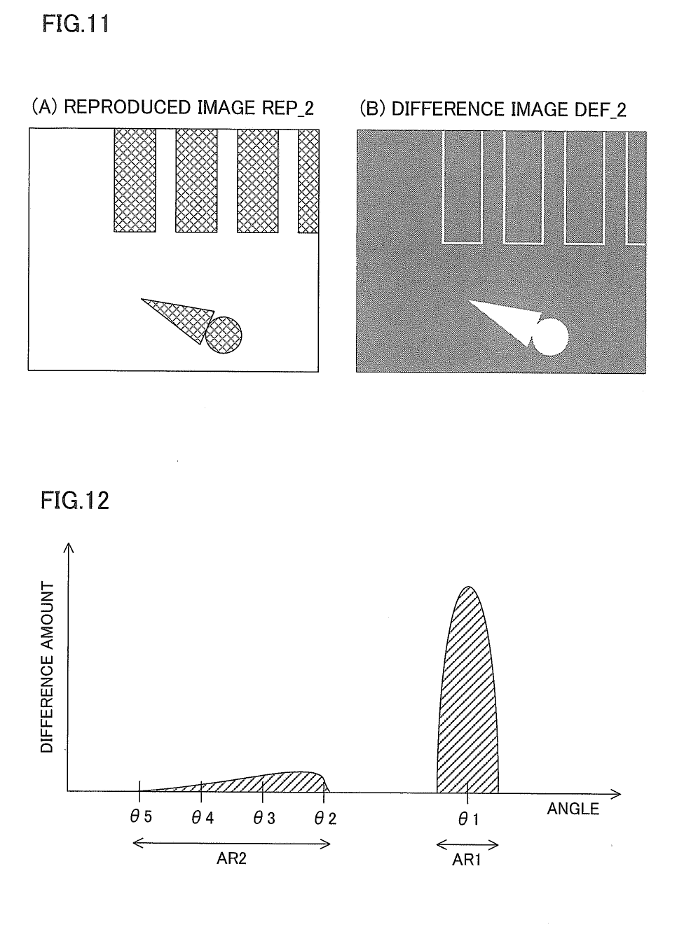

Firstly, a difference image DEF_L representing a difference between frames of a reproduced image REP_L is created by a difference calculating process. When the automobile 100 is moved, a position aligning process for aligning positions performed in consideration of the movement of the automobile 100 between the difference image REP_L in a preceding frame and the difference image REP_L in a current frame is executed before the difference calculating process. As a result, for the reproduced image REP_2 shown in FIG. 11(A), a difference image DEF_2 shown in FIG. 11(B) is created.

The obstacle 200 is steric, and thus, when the image of the dynamic and steric obstacle 200 captured from an oblique direction is transformed into the bird's-eye view image, irrespective of the position alignment between the frames, the bird's-eye view image of the obstacle 200 in a current frame differs, in principle, from the bird's-eye view image of the obstacle 200 in a preceding frame. Therefore, in the difference image DEF_2, a high luminance component representing the obstacle 200 clearly appears.

In contrary, the pattern 300 depicted on the ground is in the form of a plane, and thus, when the position between the frames is aligned, the bird's-eye view image of the pattern 300 in a current frame matches, in principle, the bird's-eye view image of the pattern 300 in a preceding frame. However, in reality, resulting from an error in a process for transforming into a bird's-eye view image and an error in position alignment between frames, a high luminance component representing a profile of the pattern 300 appears in the difference image DEF_2.

When the difference image DEF_L is created, a histogram representing a luminance distribution of the difference image DEF_L in a rotation direction of a reference axis RAX_L is created. For the difference image DEF_2 shown in FIG. 11(B), a histogram shown in FIG. 12 is created.

Subsequently, one or at least two angle ranges (angle range: an angle range in a rotation direction of the reference axis RAX_L), continuously having a significant difference amount is specified from the histogram. The specified angle ranges are designated as analysis ranges in which whether or not the dynamic obstacle exists is analyzed. According to FIG. 12, the significant difference amount appears continuously in each of angle ranges AR1 and AR2. Therefore, each of the angle ranges AR1 and AR2 is designated as the analysis range.

A size of the designated analysis range is compared with a reference value REF. Then, when the size of the analysis range falls below the reference value REF, one connecting line axis extending from the reference point RP_L in parallel to the ground is defined as an angle equivalent to a center of the analysis range. In contrary, when the size of the analysis range is equal to or more than the reference value REF, a plurality of connecting line axes extending from the reference point RPL in parallel to the ground are defined, having a uniform angle being provided between each connecting line axis, over the whole region of the analysis range.

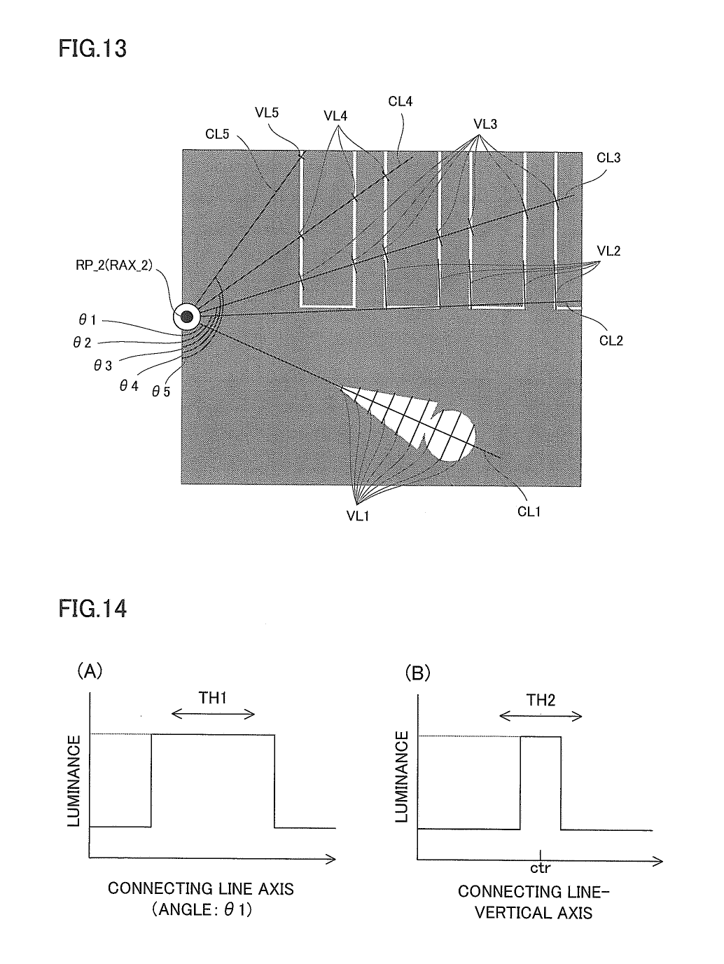

As a result, for the analysis range AR1 shown in FIG. 12, one connecting line axis CL1 corresponding to an angle θ1 is defined as shown in FIG. 13. Moreover, for the analysis range AR2, four connecting line axes CL2 to CL5 which respectively correspond to angles θ2 to θ5 are defined as shown in FIG. 13.

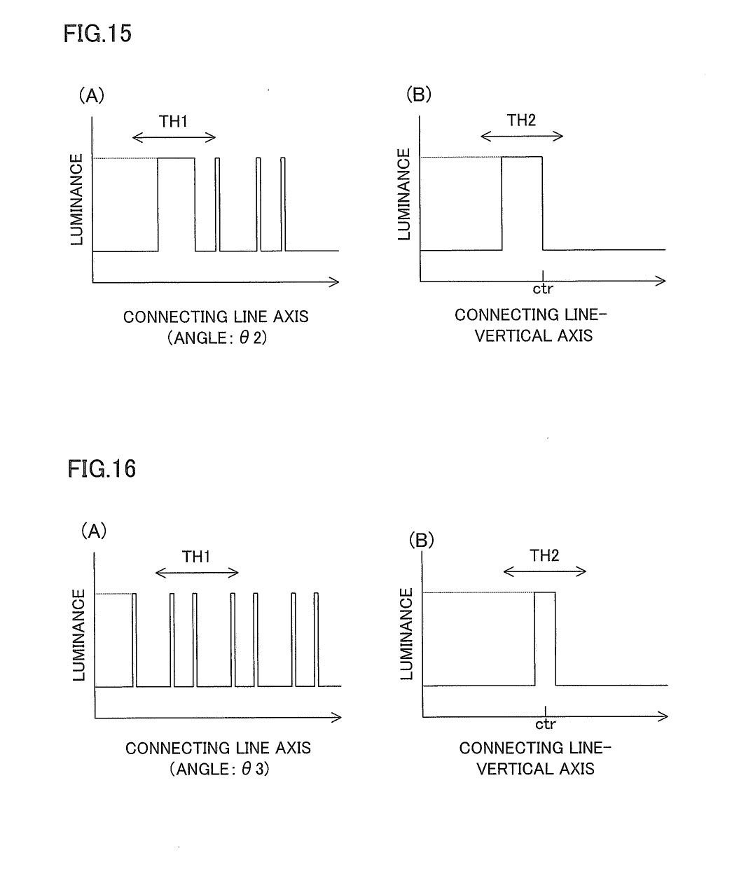

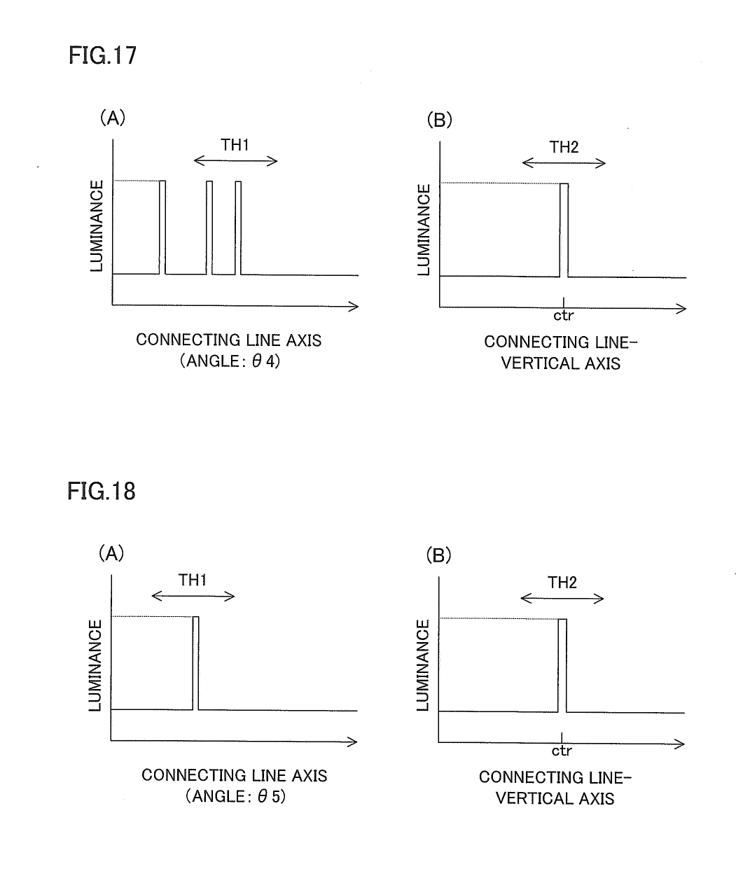

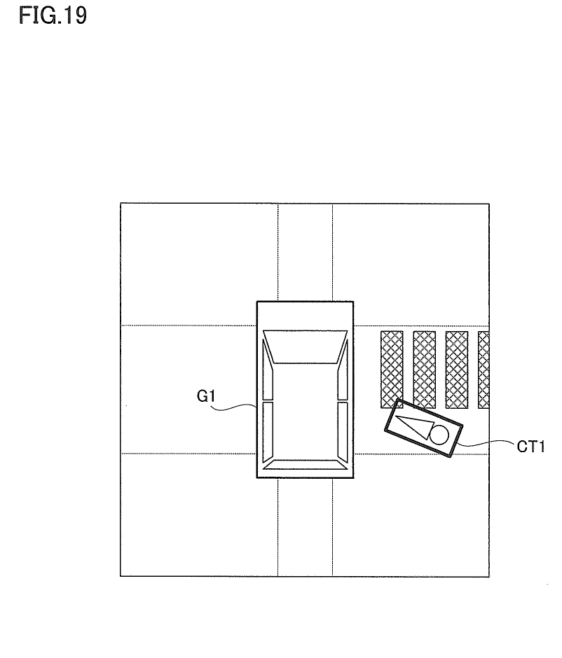

Subsequently, one or at least two connecting-line-axis graphs, which respectively correspond to the one or at least two defined connecting line axes, are created. The created connecting-line-axis graphs represent a luminance change of a difference image along the connecting line axis to be noticed. Therefore, for the connecting line axis CL1 shown in FIG. 13, a connecting-line-axis graph shown in FIG. 14(A) is created, and for the connecting line axis CL2 shown in FIG. 13, a connecting-line-axis graph shown in FIG. 15(A) is created. Moreover, for the connecting line axis CL3 shown in FIG. 13, a connecting-line-axis graph shown in FIG. 16(A) is created, and for the connecting line axis CIA shown in FIG. 13, a connecting-line-axis graph shown in FIG. 17(A) is created. Furthermore, for the connecting line axis CL5 shown in FIG. 13, a connecting-line-axis graph shown in FIG. 18(A) is created.

Moreover, one or at least two positions (position: position on the connecting line axis) having a significant difference amount are detected based on the connecting-line-axis graph created according to the above-described manner. In each of the one or at least two detected positions, a connecting-line vertical axis, which is an axis orthogonal to the connecting line axis, is defined. The defined connecting-line vertical axis has a length equivalent to the continuous significant difference amount.

Therefore, as shown in FIG. 13, on the connecting line axis CL1, nine connecting-line vertical axes VL1 are defined, and on the connecting line axis CL2, five connecting-line vertical axes VL2 are defined. Moreover, on the connecting line axis CL3, seven connecting-line vertical axes VL3 are defined, and on the connecting line axis CL4, three connecting-line vertical axes VIA are defined. Furthermore, on the connecting line axis CL5, one connecting-line vertical axis VL5 is defined.

The connecting-line-vertical-axis graph is created for each connecting line axis by noticing the one or at least two connecting-line vertical axis thus defined. The created connecting-line-vertical-axis graph represents an average of one or at least two luminance changes, which respectively lay along the one or at least two connecting-line vertical axes defined on the connecting line axis to be noticed.

Thereby, a connecting-line-vertical-axis graph shown in FIG. 14(B) is created corresponding to the connecting line axis CL1, and a connecting-line-vertical-axis graph shown in FIG. 15(B) is created corresponding to the connecting line axis CL2. Moreover, a connecting-line-vertical-axis graph shown in FIG. 16(B) is created corresponding to the connecting line axis CL3, and a connecting-line-vertical-axis graph shown in FIG. 17(B) is created corresponding to the connecting line axis CIA. Moreover, a connecting-line-vertical-axis graph shown in FIG. 18(B) is created corresponding to the connecting line axis CL5.

Thus, upon completion of the connecting-line-axis graph and the connecting-line-vertical-axis graph, which correspond to each of the angles θ1 to θ5, whether or not a luminance characteristic indicated by the connecting-line-axis graph and the connecting-line-vertical-axis graph satisfies a predetermined condition is determined corresponding to each of the angles θ1 to θ5. Herein, the predetermined condition is equivalent to a condition under which a magnitude of a range in which a luminance level continuously rises in the connecting-line-axis graph exceeds a threshold value TH1 and a magnitude of a range in which a luminance level continuously rises in the connecting-line-vertical-axis graph falls below a threshold value TH2.

As described above, the image of the steric obstacle 200 is reproduced as if to have fallen along the connecting line L linking the camera C_2 and the bottom of the obstacle 200. Moreover, when the image (captured from an oblique direction) of the dynamic and steric obstacle 200 is transformed into the bird's-eye view image, the transformed bird's-eye view image differs, in principle, between the frames. Thereby, the high luminance component representing the obstacle 200 clearly appears in the difference image DEF_2.

Therefore, a luminance level of the difference image corresponding to the obstacle 200 rises in a wide range in the connecting-line-axis graph while rises in a narrow range in the connecting-line-vertical-axis graph.

In contrary, the bird's-eye view image corresponding to the pattern 300 that is in the form of a plane and that is depicted on the ground matches, in principle, between the frames. Thus, with respect to the pattern 300, resulting from the error in a process for transforming into a bird's-eye view image or an error in position alignment between frames, the profile of the pattern 300 merely appears in the difference image DEF_2. Therefore, a luminance level of the difference image corresponding to the pattern 200 rises in narrow ranges of both of the connecting-line-axis graph and the connecting-line-vertical-axis graph.

Graphs that satisfy the predetermined condition are the connecting-line-axis graph shown in FIG. 14(A) and the connecting-line-vertical-axis graph shown in FIG. 14(B). Therefore, these graphs are specified as the graphs corresponding to the obstacle 200.

An area in which the obstacle 200 exists (area: an area on the reproduced image REP_2) is detected based on the specified connecting-line-axis graph and connecting-line-vertical-axis graph. In the detected area, a rectangular character CT1 is displayed as shown in FIG. 19. Thereby, the existence of the obstacle 200 is notified to a driver.

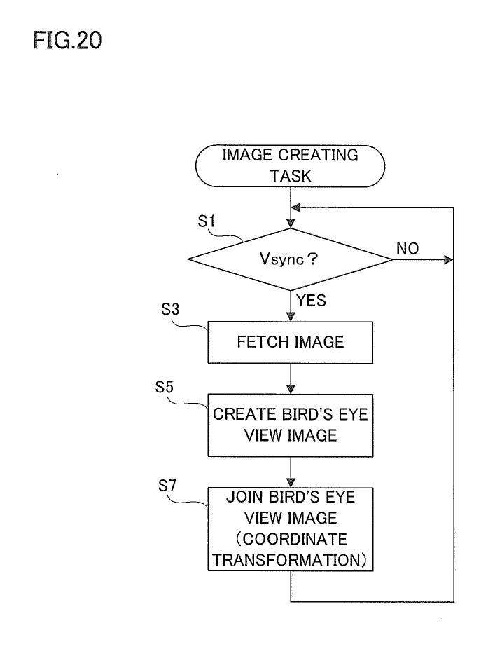

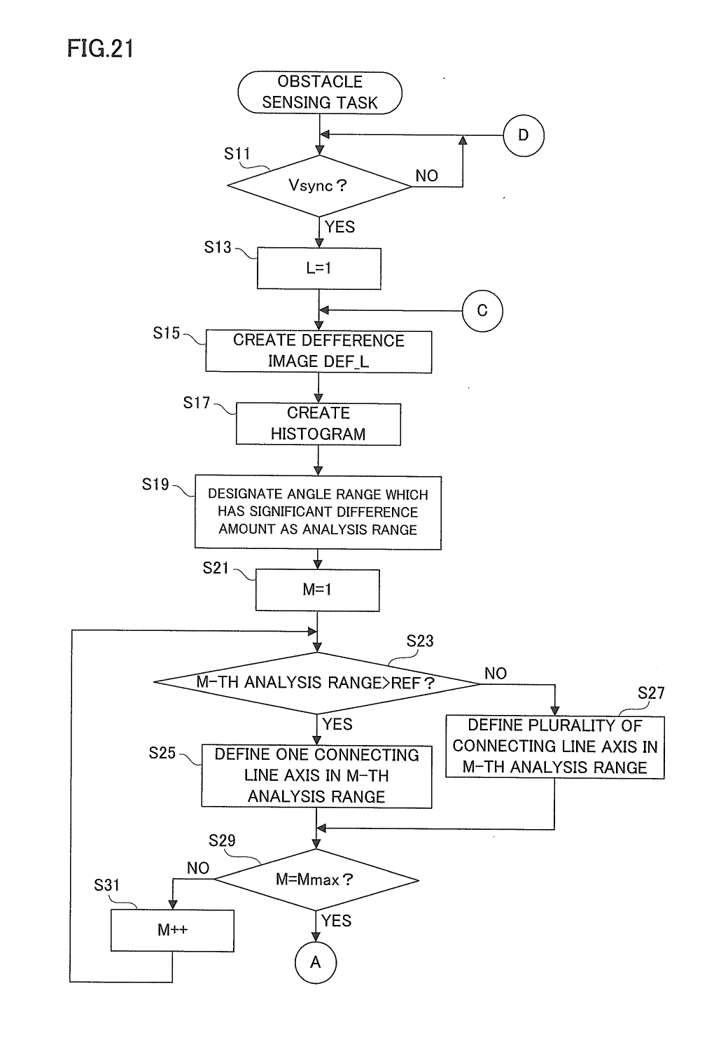

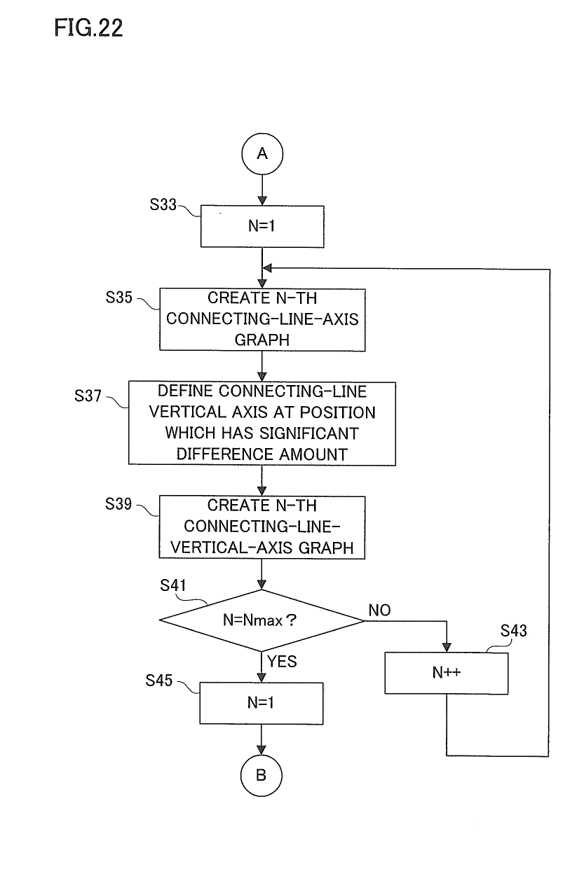

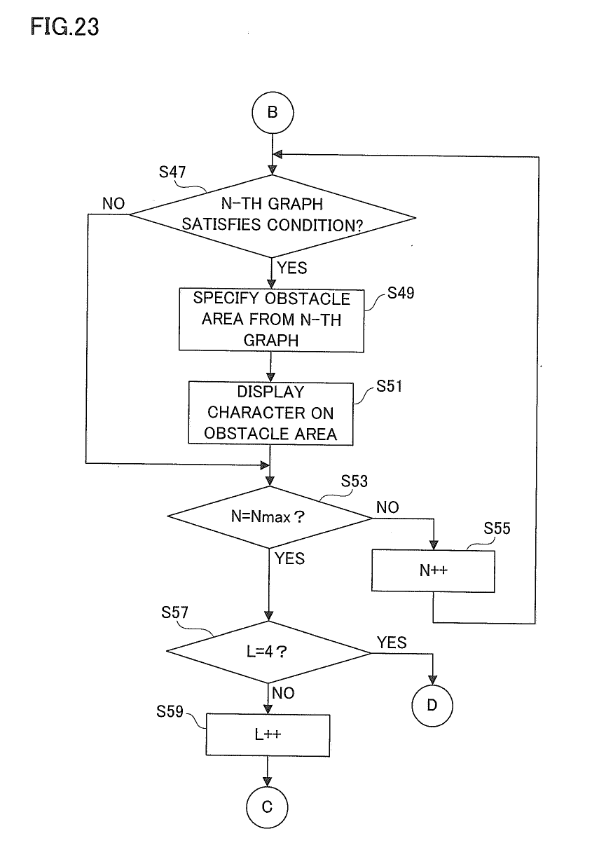

The CPU 12p specifically executes a plurality of tasks in parallel, including an image creating task shown in FIG. 20 and an obstacle sensing task shown in FIG. 21 to FIG. 23. It is noted that a control program corresponding to these tasks is stored in a flash memory 16 (see FIG. 1).

With reference to FIG. 20, when the vertical synchronization signal Vsync is generated, the process advances from a step S1 to a step S3 so as to fetch the object scene images P_1 to P_4 from the cameras C_1 to C_4, respectively. The fetched object scene images P_1 to P_4 are accommodated in the work areas F1 to F4, respectively. In a step S5, based on the fetched object scene images P_1 to P_4, the bird's-eye view images BEV_1 to BEV_4 are created. In a step S7, a coordinate transformation is applied to the bird's-eye view images BEV_2 to BEV_4 so as to join the bird's-eye view image BEV_1 to BEV_4 with each other. On the monitor screen of the display device 16, one portion of the whole-circumference bird's-eye view image joined by the coordinate transformation and the graphic image G1 multiplexed thereon are displayed as a maneuver assisting image. Upon completion of the process in the step S7, the process returns to the step S1.

With reference to FIG. 21, in a step S11, whether or not the vertical synchronization signal Vsync is generated is determined. When a determination result is updated from NO to YES, the variable L is set to “1” in a step S13. In a step S15, in order to create the difference image DEF_L representing the difference between the reproduced image REP_L in a preceding frame and the difference image REP_L in a current frame, the difference calculating process is executed. When the automobile 100 is moving, aligning positions between frames in consideration of this movement is performed first, and then, the difference calculating process is executed. In a subsequent step S17, a histogram of the difference image DEF_L obtained by the difference calculating process is created. The histogram shows the luminance distribution of the difference image DEF_L in a rotation direction of the reference axis RAX_L.

In a step S19, one or at least two angle ranges (angle range: an angle range in a rotation direction of the reference axis RAX_L), each of which continuously has a significant difference amount, is specified with reference to the histogram created in the step S17, and each of one or at least two specified angle ranges is designated as the analysis ranges. In a step S21, in order to notice a first analysis range, out of one or at least two designated analysis ranges, a variable M is set to “1”.

In a step S23, it is determined whether or not the magnitude of an M-th analysis range exceeds the reference value REF. When YES is determined, the process advances to a step S25, and on the other hand, when NO is determined, the process advances to a step S27. In the step S25, one connecting line axis extending from the reference point RP_L in parallel to the ground is defined at a center of the M-th analysis range. In the step S27, a plurality of connecting line axis extending from the reference point RP_L in parallel to the ground are defined, having a uniform angle being provided between each connecting line axis, over the whole region of the M-th analysis range.

In a step S29, it is determined whether or not the variable M reaches a total number (=Mmax) of analysis ranges specified in the step S19. When NO is determined in this step, the variable M is incremented in a step S31, and thereafter, the process is returned to the step S23. As a result, in each of one or at least two analysis ranges specified in the step S19, one or at least two connecting line axes are defined.

When the variable M reaches the total number Mmax, the process advances from the step S29 to a step S33 so as to set the variable N to “1”. In a step S35, out of one or at least two connecting line axes defined according to the above-described manner, an N-th connecting line axis is noticed to create an N-th connecting-line-axis graph. The created N-th connecting-line-axis graph represents the luminance change of the difference image along the N-th connecting line axis.

In a step S37, one or at least two positions having a significant difference amount are detected from the N-th connecting-line-axis graph, and the connecting-line vertical axis, which is orthogonal to the connecting line axis, is defined in each of the detected one or at least two positions. In a step S39, one or at least two defined connecting-line vertical axes are noticed to create the connecting-line-vertical-axis graph. The created connecting-line-vertical-axis graph represents an average of luminance changes (luminance change: a luminance change of the difference image) along each of one or at least two defined connecting-line vertical axes.

In a step S41, it is determined whether or not the variable N reaches the total number (=Nmax) of connecting line axes defined in the step S25 or S27. When NO is determined in this step, the variable N is incremented in a step S43, and thereafter, the process is returned to the step S35. As a result, the connecting-line-axis graph and the connecting-line-vertical-axis graph, which correspond to each of the connecting line axes equivalent to the total number Nmax, are obtained.

When YES is determined in the step S41, the variable N is set again to “1” in a step S45. In a step S47, it is determined whether or not the luminance changes in the N-th connecting-line-axis graph and connecting-line-vertical-axis graph satisfy the predetermined condition. When NO is determined, the process directly advances to a step S53 while YES is determined, the process advances to the step S53 via steps S49 to S51.

In the step S49, based on the N-th connecting-line-axis graph and connecting-line-vertical-axis graph, an area in which the dynamic obstacle exists is specified on the reproduced image REP_L. In the step S51, in order to multiplex the rectangular character on the reproduced image REP_L corresponding to the area specified in the step S49, a corresponding instruction is applied to the display device 14.

In a step S53, it is determined whether or not the variable N reaches “Nmax”, and when NO is determined, the variable N is incremented in a step S55, and then, the process returns to the step S47. When YES is determined in the step S53, it is determined whether or not the variable L reaches “4” in a step S57. When NO is determined, the variable L is incremented in a step S59, and then, the process returns to the step S15. When YES is determined, the process directly returns to the step S11.

As can be seen from the above description, the CPU 12p fetches the object scene images P_1 to P_4 repeatedly outputted from the cameras C_1 to C_4 capturing the object scene in a direction which obliquely intersects the ground (reference surface) (S3). The fetched object scene images P_1 to P_4 are transformed by the CPU 12p into the bird's-eye view images BEV_1 to BEV_4, respectively (S5). The difference between the screens of the transformed bird's-eye view images BEV_1 to BEV_4 is also detected by the CPU 12p (S15). The CPU 12p specifies one portion of difference along the connecting line axis extending in parallel to the ground from each of the reference points RP_1 to RP_4 corresponding to the center of the imaging surfaces of the cameras C_1 to C_4, out of the difference between the screens of each of the bird's-eye view images BEV_1 to BEV_4 (S35). Moreover, the CPU 12p specifies one portion of difference along the connecting-line vertical axis extending in parallel to the ground in a manner to intersect the connecting line axis, out of the difference between the screens of each of the bird's-eye view images BEV_1 to BEV_4 (S39). When the difference thus specified satisfies the predetermined condition, the CPU 12p multiplexes the rectangular character on the maneuver assisting image corresponding to the position of the obstacle area in order to notify the existence of the obstacle (S47 to S51).

The difference to be noticed in this embodiment is equivalent to the difference between the screens of each of the bird's-eye view images BEV_1 to BEV_4 corresponding to the object scene image captured in a direction which obliquely intersects the ground. Therefore, when the dynamic obstacle exists in a position corresponding to the connecting line axis, a difference equivalent to a height of the dynamic obstacle is specified along the connecting line axis, and a difference equivalent to a width of the dynamic obstacle is specified along the connecting-line vertical axis. On the other hand, when the pattern depicted on the ground or the static obstacle exists in a position corresponding to the connecting line axis, a difference equivalent to the error in the process for transforming into the bird's-eye view images BEV_1 to BEV_4 is specified along the connecting line axis and the connecting-line vertical axis. When it is determined whether or not the difference thus specified satisfies the predetermined condition, it becomes possible to improve the performance for sensing a dynamic obstacle.

Notes relating to the above-described embodiment will be shown below. It is possible to arbitrarily combine these notes with the above-described embodiment unless any contradiction occurs.

The coordinate transformation for producing a bird's-eye view image from a photographed image, which is described in the embodiment, is generally called a perspective projection transformation. Instead of using this perspective projection transformation, the bird's-eye view image may also be optionally produced from the photographed image through a well-known planer projection transformation. When the planer projection transformation is used, a homography matrix (coordinate transformation matrix) for transforming a coordinate value of each pixel on the photographed image into a coordinate value of each pixel on the bird's-eye view image is previously evaluated at a stage of a camera calibrating process. A method of evaluating the homography matrix is well known. Then, during image transformation, the photographed image may be transformed into the bird's-eye view image based on the homography matrix. In either way, the photographed image is transformed into the bird's-eye view image by projecting the photographed image on the bird's-eye view image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An obstacle sensing apparatus, comprising:
a fetcher which fetches an object scene image repeatedly outputted from an imager which captures an object scene in a direction which obliquely intersects a reference surface;
a transformer which transforms the object scene image fetched by said fetcher into a bird's-eye view image;
a detector which detects a difference between screens of the bird's-eye view image transformed by said transformer;
a first specifier which specifies one portion of difference along a first axis extending in parallel to the reference surface from a reference point corresponding to a center of an imaging surface, out of the difference detected by said detector;
a second specifier which specifies one portion of difference along a second axis extending in parallel to the reference surface in a manner to intersect the first axis, out of the difference detected by said detector; and
a generator which generates a notification when the difference specified by said first specifier and the difference specified by said second specifier satisfy a predetermined condition.

2. An obstacle sensing apparatus according to claim 1, further comprising a first definer which defines the first axis corresponding to each of one or at least two angles in a rotation direction of a reference axis extending from the reference point in a manner to be perpendicular to the reference surface, wherein
said first specifier executes a difference specifying process in association with a defining process of said first definer.

3. An obstacle sensing apparatus according to claim 2, further comprising a creator which creates a histogram representing a distributed state in the rotation direction of the difference detected by said detector, wherein
said first definer executes the defining process with reference to the histogram created by said creator.

4. An obstacle sensing apparatus according to claim 1, further comprising a second definer which defines the second axis in each of one or at least two positions corresponding to the difference specified by said first specifier, wherein
said second specifier executes a difference specifying process in association with a defining process of said second definer.

5. An obstacle sensing apparatus according to claim 1, wherein
the difference specified by said second specifier is equivalent to a difference continuously appearing along the second axis.

6. An obstacle sensing apparatus according to claim 1, wherein
the predetermined condition is equivalent to a condition under which a size of the difference specified by said first specifier exceeds a first threshold value and a size of the difference specified by said second specifier falls below a second threshold value.
